(19) United States
(12) Patent Application Publication
(10) Pub. No.: US 2014/0133054 A1
(43) Pub. Date: May 15, 2014

(54) SAFETY APPARATUS AND MONITORING METHOD FOR A POWER TRANSFORMER, AND RELATED POWER TRANSFORMER

(71) Applicant: ABB TECHNOLOGY AG, Zurich (CH)

(72) Inventors: Carlo CAROLLO, Thiene (VI) (IT); Andrea TONIN, Brogliano (VI) (IT); Emanuele RAMPONI, Arzignano (VI) (IT)

(73) Assignee: ABB TECHNOLOGY AG, Zurich (CH)

(21) Appl. No.: 14/162,169

(22) Filed: Jan. 23, 2014

Related U.S. Application Data
(63) Continuation of application No. PCT/EP2011/062760, filed on Jul. 25, 2011.

(51) Int. Cl. H01F 27/40; H01F 27/12

(52) U.S. Cl. CPC H01F 27/402; H01F 27/12
USPC 361/36

(57) ABSTRACT

A safety apparatus and method for monitoring a liquid-filled power transformer wherein there is provided a sensing device associated with an electronic unit. The sensing device is suitable to be at least partially immersed into liquid and includes at least one movable part displaceable by movements of the liquid. The electronic unit detects signals indicative of an actual position of the movable part and is arranged to provide, based on the detected signals, data related to actual conditions of the transformer and/or of its cooling liquid.

### RELATED APPLICATION(S)

This application claims priority as a continuation application under 35 U.S.C. §120 to PCT/EP2011/062760 filed as an International Application on Jul. 25, 2011 designating the U.S., the entire content of which is hereby incorporated by reference in its entirety.

### FIELD

The present disclosure relates to a safety apparatus for an associated liquid-filled power transformer, to a related method for monitoring a power transformer, and to a power transformer including such a safety apparatus.

### BACKGROUND INFORMATION

Known electrical induction devices, for example power transformers, can exploit the electromagnetic induction for transmitting and distributing electricity over power lines.

Known power transformers include live parts, for example, a magnetic core composed by one or more legs or limbs connected by yokes which together form one or more core windows. For each phase, around the legs there can be arranged a number of windings, for example low-voltage windings, high-voltage windings, etc.

Due to the intrinsic structural characteristics and functioning of these devices, aspects of power transformers concern the electric insulation among the various components and cooling thereof provided in order to provide the desired electromagnetic performance without malfunction or damage.

To this end, a power transformer can include a closed main tank which is filled with an insulating fluid. The insulating fluid can be a liquid, for example, a highly-refined mineral oil that is stable at high temperatures and has electrical insulating properties. Combustion-resistant vegetable oil-based dielectric coolants are also becoming increasingly common as alternatives to mineral oils.

In addition, power transformers can be provided with expansion vessels generally indicated as oil conservators. Such conservators can be positioned above the main tank, and have the function of compensating for volume changes of the cooling fluid used in the tank, which volume changes can result from temperature fluctuations.

Because the insulating liquid helps cooling of the transformer and also contributes to the electrical insulation between live parts inside the tank, it is stable at high temperatures for an extended period.

During the working life of a power transformer, it is possible that gas is generated or present inside the tank. This is an indication of a possible problem.

For example, the gas may be the result of decomposition/degradation of the solid or liquid insulation inside the transformer caused by overheating or by the strike of electric arcs. The gas may come from the insulating oil itself due to unsatisfactory de-gassing prior to filling the tank.

In addition, rapid movements, also indicated as rapid currents or flows of the transformer liquid, can be caused by an internal arc, short circuit, or hot spot. These rapid movements can be indicative of possible abnormal or dangerous conditions and should be properly addressed.

To this end, power transformers can be equipped with safety devices, for example Buchholz relays, so that the generation of gas and the presence of rapid movements can be detected and related risks mitigated to the extent possible.

Although known solutions perform their functions, there is still desire and room for further improvement.

Such a desire can be fulfilled by a safety apparatus suitable to be associated to a power transformer including a tank filled with a cooling liquid. The safety apparatus includes an electronic unit and a sensing device suitable to be at least partially immersed into the cooling liquid and including at least one movable part which is displaceable by movements of the cooling liquid. The sensing device is arranged to output signals indicative of the actual position of the at least one movable part. The electronic unit is arranged so as to provide, based on the output signals, data related to actual conditions of the transformer or of its cooling liquid.

This desire can be achieved by a method for monitoring a power transformer of the type including a tank filled at least partially with a cooling liquid. The method can include:

(a) providing a sensing device suitable to be at least partially immersed into the cooling liquid and including at least one movable part (11) which is displaceable by movements of the cooling liquid, the sensing device being arranged to output signals indicative of the actual position of the at least one movable part; and

(b) based on the output signals, providing, by an electronic unit data related to actual conditions of the transformer or of its cooling liquid.

### SUMMARY

A safety apparatus is disclosed for a power transformer including a tank filled with a cooling liquid, the safety apparatus comprising an electronic unit and a sensing device for at least partial immersion into the cooling liquid and including at least one movable part displaceable by movements of cooling liquid, the sensing device being configured to output signals indicative of an actual position of the at least one movable part, wherein the electronic unit is configured to provide, based on the output signals, data related to actual conditions of the transformer or of its cooling liquid.

A power transformer is disclosed comprising a tank at least partially filled with a cooling liquid and a safety apparatus including an electronic unit, and a sensing device for partial immersion into the cooling liquid and including at least one movable part displaceable by movements of the cooling liquid, the sensing device arranged to output signals indicative of the actual position of the at least one movable part, wherein the electronic unit is arranged so as to provide, based on the output signals, data related to actual conditions of the transformer or of its cooling liquid.

A method is disclosed for monitoring a power transformer having a tank filled at least partially with a cooling liquid, the method comprising (a) providing a sensing device suitable for at least partial immersion into the cooling liquid, the sensing device including at least one movable part which is displaceable by movements of the cooling liquid, the sensing device being configured to output signals indicative of an actual position of the at least one movable part and (b) based on the output signals, providing, by an electronic unit, data related to actual conditions of the transformer or of its cooling liquid.

### BRIEF DESCRIPTION OF THE DRAWINGS

Detailed characteristics and advantages will become apparent from the description of some preferred but not exclusive embodiments of a safety apparatus and method according to the present disclosure, illustrated only by way of non-limitative examples with the accompanying drawings, wherein:

FIG. 1 is a view illustrating a power transformer equipped with a safety apparatus according to an exemplary embodiment of the present disclosure;

FIG. 2 is a perspective view, partial section, showing an exemplary embodiment of a safety apparatus according to the present disclosure;

FIG. 3 is a perspective view illustrating some components of the safety apparatus of FIG. 2;

FIG. 4 is a perspective views showing an exemplary embodiment of a sensing device usable in a safety apparatus according to exemplary embodiments of the present disclosure;

FIG. 5 is a schematic view illustrating another exemplary embodiment of a safety apparatus according to the present disclosure; and

FIG. 6 is a block diagram schematically representing an exemplary embodiment of a method for monitoring a power transformer according to the present disclosure.

### DETAILED DESCRIPTION

It should be noted that in the detailed description that follows, identical or similar components, either from a structural and/or functional point of view, have the same reference numerals, regardless of whether they are shown in different embodiments of the present disclosure. It should also be noted that in order to clearly and concisely describe the present disclosure, the drawings may not necessarily be to scale and certain features of the disclosure may be shown in somewhat schematic form.

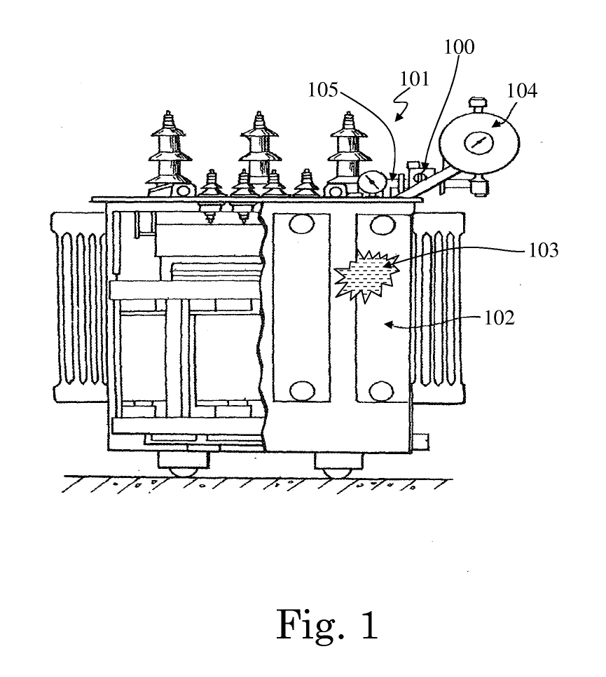

FIG. 1 shows an exemplary power transformer 101 including a tank 102 filled with a cooling/insulating liquid 103 (hereinafter referred to as cooling liquid 103 for the sake of conciseness) of a type known per se, for example a mineral or vegetal oil. An expansion vessel or conservator 104, also filled with the cooling liquid 103, is mechanically connected to the tank 102 and is positioned as shown on top of the tank 102 itself.

A suitable pipe system 105 realizes the fluid communication between the conservator 104 and the tank 102.

As illustrated in FIG. 1, the transformer 101 is equipped with at least one safety apparatus 100 according to an exemplary embodiment of the present disclosure, which is for example fitted in the pipe system 105 along the fluid path leading from the tank 102 to the conservator 104.

The safety apparatus 100 according to an exemplary embodiment of the present disclosure includes an electronic unit 1 and a sensing device 10 suitable to be at least partially immersed into the cooling liquid 103. For example, as it will be described more in detail hereinafter, the sensing device 10 includes at least one movable part 11 which is displaceable by movements of the cooling liquid 103 itself, and is arranged to output signals, for example electric signals, indicative of the actual position assumed by the movable part 11 as a consequence of movements of the cooling liquid 103.

In the exemplary embodiments, the sensing device 10 can include a potentiometer having a displaceable cursor fitted inside a float 11, for example, a linear position transducer type IC marketed by Gefran.

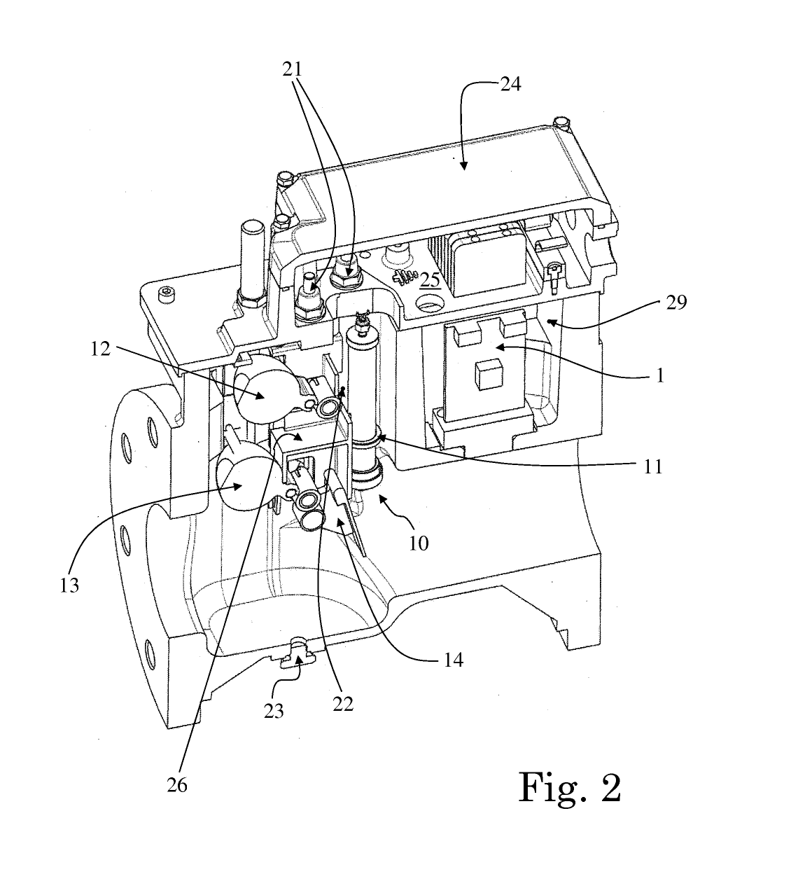

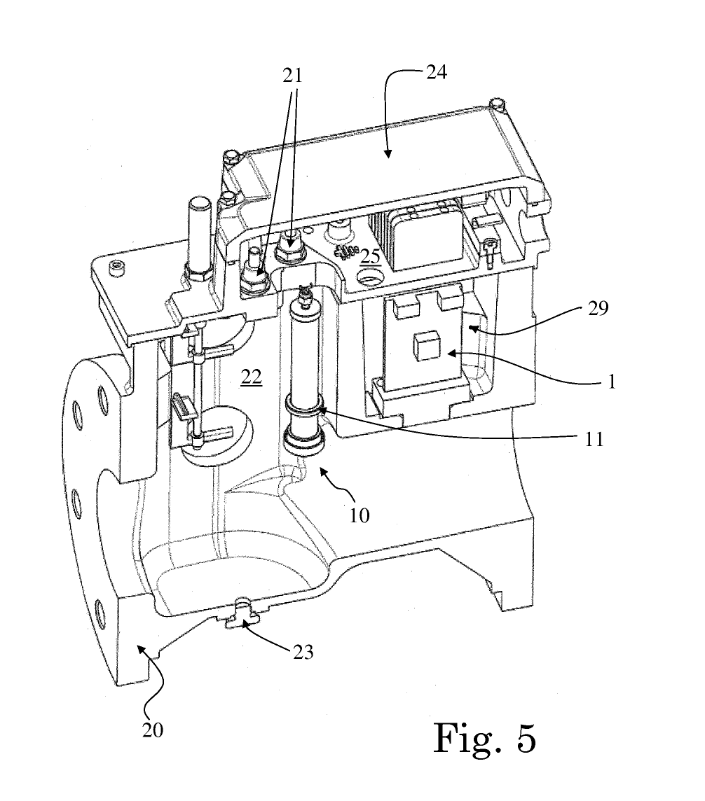

For example, the sensing device 10 can be immersed into the cooling liquid 103 directly, for example in a dedicated space of the pipe system 105 where gas-accumulation may occur, or, as schematically represented in FIG. 5 (or FIG. 2), it can be fitted inside a suitably shaped body, for example a shaped body 20, which is connected for example along the pipe system 105 and has an inner gas-accumulation space or chamber 22 to be filled at least partially with the cooling liquid 103 with the sensing device 10 immersed in it. A cover 24 is connected to the lower part of the shaped body 20 and forms a second inner space 25 inside which there are terminals 21 which are connected to output cables 17 of the sensing device, connected on a flange 16.

The electronic unit 1 is operatively connected to the sensing device 10. For example the electronic unit is connected (connections not illustrated for simplicity of illustration) to the terminals 21 wired to the sensing device 10 and is positioned inside a further inner space 29 of the body 20, or it can be positioned inside the space 25 together with the terminals 21. The electronic unit 1 is arranged so as to provide, based on the output signals produced by the sensing device 10, data related to actual conditions of the transformer 101 and/or of its cooling liquid 103.

The electronic unit 1 can be arranged so as to remotely transmit the provided data related to actual conditions of the transformer 101 and/or of the cooling liquid 103.

According to an exemplary embodiment of the present disclosure, the electronic unit 1 is arranged so as to provide at least data indicative of the actual quantity of gas accumulated by the safety apparatus 100 coming from tank 102 to conservator 104 through pipe 105, which gas accumulated is indicative of the quantity of gas generated into the transformer 101 for whatever reason.

According to an exemplary embodiment of the present disclosure, the electronic unit 1 can be arranged so as to output an alarm signal if the provided data indicative of the actual quantity of gas generated in the transformer 101 exceed a predetermined first threshold. Such an alarm signal can be of any type, for example acoustic or visual, and direct or indirect. For example it can cause switching of a lamp device or a siren, or can be routed to a switch which in turn actuates a lamp or a siren, and can be transmitted locally and/or remotely in whatever manner possible, for example through wires or wireless.

According to an exemplary embodiment of the disclosure, the electronic unit 1 can be arranged to output a trip signal if the provided data indicative of the actual quantity of gas present in the transformer 101 exceed a predetermined second threshold. This trip signal can be routed, locally and/or remotely, to an associated switch or trip unit whose intervention disconnects electric power feeding the power transformer 101.

According to an exemplary embodiment of the disclosure, the electronic unit 1 can be also arranged to provide data indicative of the actual flow rate of the cooling liquid 103, i.e. the speed of such liquid, and to output a trip signal if the provided data indicative of the flow-rate of the cooling liquid 103 exceed a predetermined third threshold. Also this trip signal can be routed, locally and/or remotely, in whatever manner, for example through cabling or wireless, to an associated switch or trip unit whose intervention disconnects electric power feeding the power transformer 101.

As those skilled in the art may appreciate, the electronic unit 1 can include any suitable and commercially available micro-processor based electronic unit which provides digital data and outputs corresponding digital signals, for example a micro-processor NXP type LPC21.

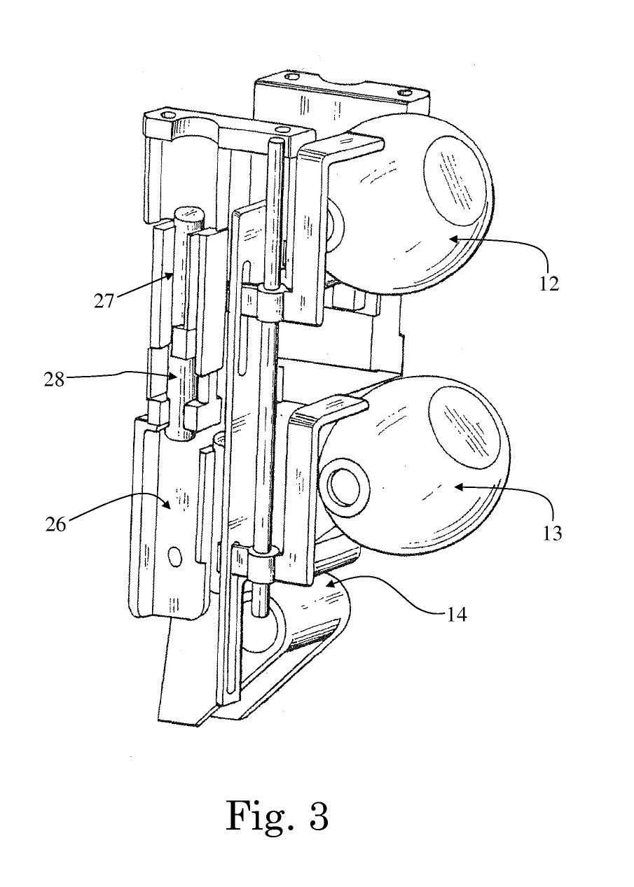

According to yet an exemplary embodiment illustrated in FIGS. 2-3, the safety apparatus 100 can include a shaped body 20 (functionally equivalent, and can be also structurally the same or similar to the body 20 of FIG. 5) which is made for example of cast aluminum alloy and is shaped to be connected to the pipe system 105 and to have a first inner gas-accumulation space 22 suitable to be filled with the cooling fluid 103. An oil drain plug 23 can be provided at the bottom part of the inner space 22.

Also in this exemplary embodiment, the body 20 is, for example, provided with a cover 24 shaped so as to form with the upper part of the body 20 a second inner space 25.

Inside the inner spacer 22 there is provided a frame 26, for example (see FIG. 3), on which seats 27 are formed for accommodating two switches 28, for example magnetic switches.

Each of the switches 28 can be of a known type and for example can have, inside a bulb, a magnet and electrical contacts, not shown in the Figures, which are directly connected, in this case, to an alarm circuit and to a disconnection circuit, respectively.

According to an exemplary embodiment of the disclosure, the safety apparatus 100 can include a first floating element 12 and a second floating element 13, both structurally independent from the movable part 11 and connected to the frame 26. The floating elements 12 and 13 are suitable to be at least partially immersed in and moved by the cooling liquid 103. The first floating element 12 is operatively coupled to and actuates a first switch 28 when the level of the cooling liquid 103 inside the transformer 101 exceeds a predetermined first threshold. The first switch 28 in this embodiment can be operatively connected to an alarm system according to solutions readily available to those skilled in the art and therefore not described herein in detail. In turn, the second floating element 13 can be operatively coupled to and actuates a second switch 28 when the level of the cooling liquid 103 inside the transformer 101 exceeds a predetermined second threshold. The second switch 28 can be operatively connected to a disconnection circuit and is suitable to cause, directly or indirectly, and according to solutions readily available to those skilled in the art and therefore not described herein in detail, disconnection of electric power feeding the power transformer 101.

According to an exemplary embodiment of the disclosure, the safety apparatus 100 can include a further movable element 14, for example a flap-shaped element, which can be, for example, pivotally connected to the frame 26 and is suitable to be at least partially immersed in and moved by the cooling liquid 103. This further movable element 14 can be arranged to detect if the actual flow-rate of the cooling liquid 103 exceeds a predetermined third threshold. For example, the further movable element 14 can be operatively coupled to a disconnection circuit, for example by a switch, such as the same switch 28. In practice when the actual flow rate of the cooling liquid 103 exceeds the related predetermined threshold, the further movable element 14 actuates a switch, for example the switch 28 which in turn is suitable to cause, directly or indirectly, and according to solutions readily available to those skilled in the art and therefore not described herein in detail, disconnection of electric power feeding the power transformer 101.

In the exemplary embodiment of FIGS. 2-3, the safety apparatus 100 can include a gas-accumulation Buchholz type relay with a potentiometer fitted inside the body of the Buchholz type relay, (e.g., inside the inner space 22), and the electronic unit 1 placed inside the space 25 together with terminals 21. The first and second floating elements 12, 13, as well as the further movable element 14 that are part of the Buchholz type relay are structurally separated from the potentiometer and its movable part 11.

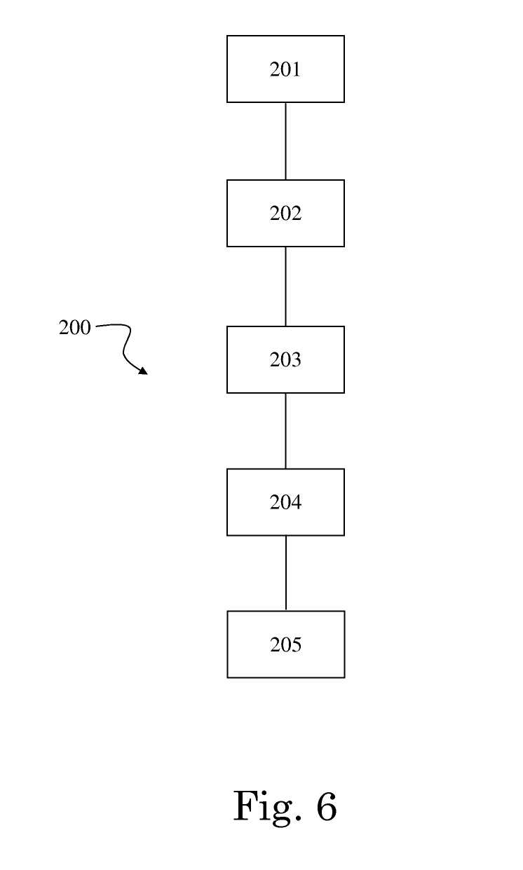

The operation of the safety apparatus 100 will be now described in more detail by reference to the schematic block diagram of FIG. 6 illustrating an exemplary method 200 for monitoring a power transformer according to an exemplary embodiment of the present disclosure.

For example, once the electronic unit 1 and a sensing device 10 of the type previously described is provided (step 201) immersed into the cooling liquid 103, during the normal functioning of the transformer, any movement of the liquid cooling 103 can cause consequent displacements of the movable element 11 which is transduced by the sensing device 10 into output electric signals. Based on such output signals, the electronic unit provides (step 202) data related to actual conditions of the transformer 100 and/or of its cooling liquid 103.

In more detail, if gas forms or becomes present inside the transformer 100 for whatever reason, it tends to escape upward and accumulates inside the body of the safety apparatus 100, for example inside the upper part of the inner space 22. As a consequence, the gas present lowers the level of the cooling liquid 103 and thus causes the movement of the float 11, for example downwards, and also the movement of the potentiometer cursor which is inside the float. Therefore, the potentiometer continuously varies in resistance values which are detected by the associated electronic unit 1 and are indicative of the actual position reached by the movable element 11 and therefore of the level reached by the liquid as a consequence of the quantity of gas actually generated in the transformer 100.

Based on such output electric signals detected, the electronic unit 1 provides data (step 203) indicative of the actual quantity of gas generated in the transformer 100. In this way, because the actual quantity of gas can be continuously derived from the actual level reached by the cooling liquid 103, it can be possible to track and have almost complete information about how much gas is present and the trend thereof over the time.

At step 204, the method according to an exemplary embodiment of the present disclosure foresees to produce an alarm signal if the quantity of gas present in the transformer 100 exceeds a predetermined first threshold. If the quantity of gas generated in the transformer 100 continues to increase and exceeds a predetermined second threshold, a trip signal is produced at step 205 so as to cause disconnection of electric power feeding the transformer 100.

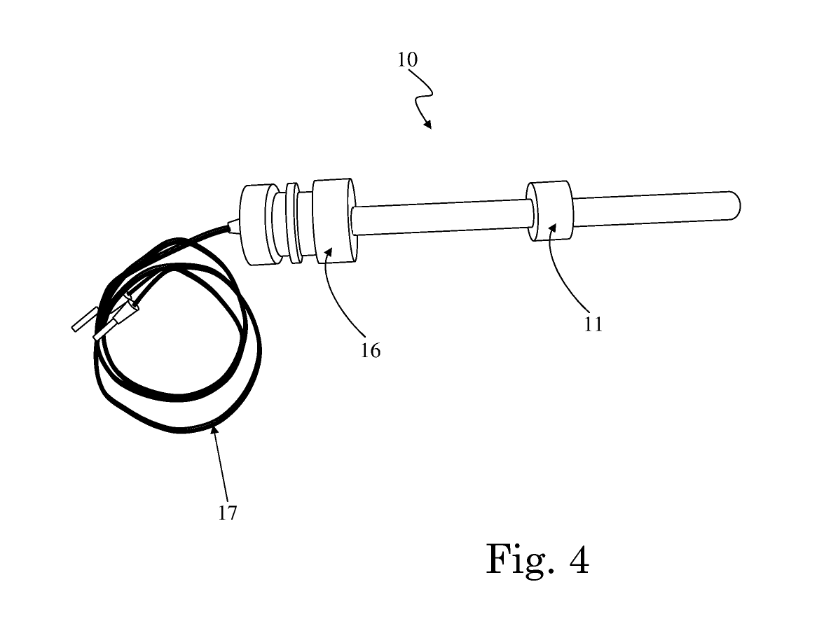

For example, according to the exemplary embodiment of FIGS. 4-5, the alarm signal of step 204 and the trip signal of step 205 can be output by the electronic unit 1 when the data provided by it and indicative of the actual quantity of gas generated in the transformer 100 exceed the predetermined first threshold or the second predetermined threshold, respectively, (e.g., the cooling liquid 103 is lowered, displacing consequently the movable element or cursor 11) below a defined first threshold level and further down below the second predetermined level threshold.

According to the exemplary embodiment of FIGS. 2-3, such alarm signal at step 204 can be produced, in addition or in alternative to the electronic unit 1, by the first floating element 12 and its associated switch 28. When accumulating, the gas lowers the level of the cooling liquid 103 which lowering is detected also first by the upper floating element 12. When the quantity of gas present is such to lower the first floating element 12 below the predefined first threshold level, the switch 28 produces, directly or indirectly, the alarm signal.

If the accumulation of gas continues, it is then detected by the lower second floating element 13. When the quantity of gas present is such that to lower the second floating element 13 below the predefined second threshold level, the switch associated to the second floating element 13 produces, (also in addition or in alternative to the electronic unit 1) directly or indirectly, the trip signal at step 205 meant to cause disconnection of electric power feeding the transformer 100.

In operation, it is also possible that for some reasons, for example a violent and sudden short circuit, strong/rapid currents of the liquid 103 are generated inside the tank. Such rapid movements of the liquid can be due to dangerous or abnormal working conditions and hence, in order to limit the negative effects, a related flow rate limit (hereinafter referred to as “third threshold”) can be defined.

To this end, according to an exemplary embodiment the present disclosure, if desired and in whichever order with respect to or even within one of the previously described steps 202-205, it is possible to detect the actual flow rate of the cooling liquid (i.e. its speed of movement) and to produce a related trip signal if the detected flow-rate of the cooling liquid exceeds the predetermined third threshold.

For example, according to the exemplary embodiment of FIGS. 4-5, movements of the liquid 103, in this case rapid movements caused, for example, by a short circuit, displace the movable element or cursor 11 which induces corresponding output electric signals at the terminal 21 each indicative of the actual position of the movable element 11 itself. The electronic unit 1 detects such electric signals and is arranged to provide also data indicative of the actual flow rate of the cooling liquid and to output a trip signal so as to cause disconnection of electric power feeding the transformer 100 if the data provided indicative of the actual flow rate of the cooling liquid exceeds the predetermined third threshold. For example, in this case the electronic unit can provide two digital data in a determined interval of time. If the ratio between the difference of the values of such two digital data and the determined interval of time during which they were provided exceeds a predetermined threshold, then the trip signal is output by the electronic unit 1 itself.

According to the exemplary embodiment of FIGS. 2-3, such trip signal can be produced, also in addition or in alternative to the electronic unit 1, by the further movable element 14 and its associated switch, for example the switch 28. According to this exemplary embodiment, the flow rate and therefore rapid currents or movements of the cooling liquid can cause the displacement, for example rotation, and hence are detected by the further movable element 14. If the flow rate of the cooling liquid exceeds the predefined third threshold then the movement of the element 14 is such that to actuate the associated switch, for example the switch 28, which produces, directly or indirectly, the trip signal meant to cause disconnection of electric power feeding the transformer 100.

In practice, it has been found that the safety apparatus 100 and method 200 according to exemplary embodiment of the present disclosure offer a solution which is rather simple, reliable, flexible and allow to obtain more information about the conditions of the transformer and/or of its cooling liquid. For example about the presence and trend over the time of gas and the occurrence of rapid liquid currents or movements inside the tank. For example, such information can be made available locally, or even remotely transmitted. Calibration can be easily determined based on customer specifications.

In addition, as previously described, depending on customer specifications, desired functionalities can be achieved according to a solution predominantly electronic. For example according to the embodiment of FIGS. 4-5 wherein the electronic unit 1 is arranged to provide data related to the actual quantity and the actual trend of gas present into the transformer as well as related to the actual flow rate of the liquid, and in case to output also intervention signals if the detected conditions require so. Alternatively and according to the exemplary embodiment of FIGS. 2 and 3, it is possible to adopt a hybrid solution where some functionalities are performed basically by the electronic unit 1 with its associated potentiometer, while some others are devoted to mechanical or electromechanical components. For example as described, the electronic unit 1 can be used just to track almost continuously the presence and evolution over the time of the gas inside the transformer, while the floating elements 12, 13, 14 can be used to produce the signals indicating discrete conditions, namely. For example the actual presence of gas is above the first threshold (floating element 12 and associated switch), or is above the second threshold (floating element 13 and associated switch 28) or the flow rate of the liquid currents exceeds the third threshold (third element 14 and associated switch 28).

Such results can be achieved due to a solution which in principle makes the safety apparatus 100 according to exemplary embodiments of the present disclosure easy to be used in connection with any type of power transformer.

Exemplary embodiments of the present disclosure can also encompass a power transformer including at least one safety apparatus 100 of the type previously described. Clearly more than one safety apparatus 100 can be used in a single power transformer.

The apparatus and method thus disclosed are subject to of modifications and variations, all of which are within the scope of the inventive concept as defined for example by the disclosure. Any possible combination of the previously disclosed embodiments can be implemented and is to be considered within the inventive concept of the present disclosure. All the details may furthermore be replaced with technically equivalent elements.

For example, any of the previously described components may be differently shaped, or used in a different number or parts or elements, or the components previously described can be differently connected with respect to each other. For example, the cover 24 can be realized in a unique piece with the rest of the body 20 or can be a separate part connected therewith. The movable part 11 can be differently shaped so as to be able to better detect the presence of rapid currents or an additional movable element, for example a flap-shaped element can be added to the sensing device for such a purpose; or a movable element like the movable flap 14 of FIG. 2 can be associated with the sensing device 10 of FIG. 5 in order to allow measuring the actual flow rate of the liquid 103.

Also the materials used, so long as they are compatible with the specific use and purpose, as well as the dimensions, may be any according to specifications and the state of the art. For example the various floating or movable elements can, for example, be made totally or partially of plastic materials but any suitable different material may be used.

Thus, it will be appreciated by those skilled in the art that the present invention can be embodied in other specific forms without departing from the spirit or essential characteristics thereof. The presently disclosed embodiments are therefore considered in all respects to be illustrative and not restricted.

What is claimed is:

1. A safety apparatus for a power transformer including a tank filled with a cooling liquid, the safety apparatus comprising:
an electronic unit; and
a sensing device for at least partial immersion into the cooling liquid and including at least one movable part displaceable by movements of cooling liquid, the sensing device being configured to output signals indicative of an actual position of the at least one movable part, wherein the electronic unit is configured to provide, based on the output signals, data related to actual conditions of the transformer or of its cooling liquid.

2. The safety apparatus according to claim 1, wherein the electronic unit is configured to remotely transmit the data.

3. The safety apparatus according to claim 1, wherein the electronic unit is configured to provide data indicative of a quantity of gas generated inside the transformer.

4. The safety apparatus according to claim 3, wherein the electronic unit is configured to output an alarm signal if the data indicative of the actual quantity of gas generated inside the transformer exceeds a predetermined first threshold.

5. The safety apparatus according claim 3, wherein the electronic unit is configured to output a trip signal if the data indicative of the actual quantity of gas generated inside the transformer exceeds a predetermined second threshold.

6. The safety apparatus according to claim 1, wherein the electronic unit is configured to provide data indicative of an actual flow rate of cooling liquid, and to output a trip signal if the data indicative of the actual flow-rate of the cooling liquid exceeds a predetermined third threshold.

7. The safety apparatus according to claim 1, wherein the sensing device comprises:
a potentiometer.

8. The safety apparatus according to claim 7, comprising:
a first floating element for at least partial immersion in and movement by cooling liquid; and
an alarm switch actuatable by the first floating element when a level of the cooling liquid generated exceeds a predetermined first threshold.

9. The safety apparatus according to claim 8, comprising:
a second floating element for at least partial immersion in and movement by, the cooling liquid; and
a trip switch actuatable by the second floating element to disconnect electric power feeding the power transformer when a level of the cooling liquid exceeds a predetermined second threshold.

10. The safety apparatus according to claim 1, comprising:
a second movable element for at least partial immersion in and movement by cooling liquid, the second movable element being configured to detect if an actual flow rate of the cooling liquid exceeds a predetermined third threshold and to actuate an associated switch suitable to disconnect electric power feeding a power transformer.

11. The safety apparatus according to claim 9, comprising:
a gas-accumulation Buchholz type relay with the potentiometer fitted inside a body of the Buchholz type relay itself, and wherein the first and second floating elements are part of the Buchholz type relay and are structurally separated from the potentiometer.

12. A power transformer comprising:
a tank at least partially filled with a cooling liquid; and
a safety apparatus including:
an electronic unit; and
a sensing device for partial immersion into the cooling liquid and including at least one movable part displaceable by movements of the cooling liquid, the sensing device arranged to output signals indicative of the actual position of the at least one movable part, wherein the electronic unit is arranged so as to provide, based on the output signals, data related to actual conditions of the transformer or of its cooling liquid.

13. A method for monitoring a power transformer having a tank filled at least partially with a cooling liquid, the method comprising:
(a) providing a sensing device suitable for at least partial immersion into the cooling liquid, the sensing device including at least one movable part which is displaceable by movements of the cooling liquid, the sensing device being configured to output signals indicative of an actual position of the at least one movable part; and
(b) based on the output signals, providing, by an electronic unit, data related to actual conditions of the transformer or of its cooling liquid.

14. The method according to claim 13, wherein (b) comprises:
providing data indicative of an actual quantity of gas generated inside the transformer.

15. The method according to claim 14, comprising:
producing an alarm signal if the quantity of gas generated inside the transformer exceeds a predetermined first threshold.

16. The method according to claim 14, comprising:
producing a trip signal if the quantity of gas generated inside the transformer exceeds a predetermined second threshold.

17. The method according to claim 13, comprising:
providing data indicative of an actual flow rate of the cooling liquid.

18. The method according to claim 17, comprising:
producing a trip signal if the actual flow-rate of the cooling liquid exceeds a predetermined third threshold.
